(19) United States
(12) Patent Application Publication
(10) Pub. No.: US 2020/0180661 A1
(43) Pub. Date: Jun. 11, 2020

(54) VEHICLE AND APPARATUS AND METHOD FOR CONTROLLING THE SAME

(71) Applicant: HONDA MOTOR CO., LTD., Tokyo (JP)

(72) Inventors: Shigehiro HONDA, Wako-shi (JP); Hironobu KIRYU, Wako-shi (JP); Kentaro ISHISAKA, Wako-shi (JP); Takuyuki MUKAI, Wako-shi (JP)

(21) Appl. No.: 16/792,497

(22) Filed: Feb. 17, 2020

Related U.S. Application Data
(63) Continuation of application No. PCT/JP2017/031617, filed on Sep. 1, 2017.

(51) Int. Cl. B60W 60/00; B60W 50/14

(52) U.S. Cl. CPC B60W 60/0059; B60W 60/0057; B60W 2050/0072; B60W 60/00186; B60W 50/14; B60W 60/0054

(57) ABSTRACT

A control apparatus of a vehicle includes a function determination unit that determines whether functions of a travel control unit and an actuator group have deteriorated, and a switching control unit that controls switching between automated driving and manual driving. During a driving handover notification for requesting a driver to switch to the manual driving, the travel control unit performs the automated driving in a first mode when the functions of the travel control unit and the actuator group have not deteriorated, and the automated driving in a second mode when the functions of the travel control unit and the actuator group have deteriorated. A degree of deceleration in the automated driving in the second mode is greater than a degree of deceleration in the automated driving in the first mode.

### CROSS-REFERENCE TO RELATED APPLICATION

This application is a continuation of International Patent Application No. PCT/JP2017/031617 filed on Sep. 1, 2017, the entire disclosure of which is incorporated herein by reference.

### BACKGROUND OF THE INVENTION

### Field of the Invention

The present invention relates to a vehicle and an apparatus and method for controlling the same.

### Description of the Related Art

Japanese Patent Laid-Open No. 9-161196 describes a control apparatus that controls switching between automated driving and manual driving of a vehicle. The control apparatus detects that the vehicle approaches a point where the automated driving is scheduled to be switched to the manual driving and forcibly decelerates the vehicle when the control apparatus determines that the switching of the automated driving to the manual driving will not be completed before the vehicle reaches the scheduled point.

### SUMMARY OF THE INVENTION

When the automated driving is switched to the manual driving, it is desirable to perform smooth handover of the driving control to the driver. An aspect of the present invention provides a technique for smoothly performing the handover performed when the automated driving is switched to the manual driving.

According to some embodiments, there is provided a control apparatus of a vehicle including a travel control unit that performs automated driving and an actuator group controlled by the travel control unit, the control apparatus comprising: a function determination unit that determines whether functions of the travel control unit and the actuator group have deteriorated and a switching control unit that controls switching between the automated driving and manual driving, wherein when it is determined that the automated driving needs to be switched to the manual driving, the switching control unit issues driving handover notification for requesting a driver to switch to the manual driving, during the driving handover notification, the travel control unit performs the automated driving in a first mode when the functions of the travel control unit and the actuator group have not deteriorated, and the automated driving in a second mode when the functions of the travel control unit and the actuator group have deteriorated, and wherein a degree of deceleration in the automated driving in the second mode is greater than a degree of deceleration in the automated driving in the first mode.

Other features and advantages of the present invention will be apparent from the following description taken in conjunction with the accompanying drawings. Note that the same reference numerals denote the same or like components throughout the accompanying drawings.

### BRIEF DESCRIPTION OF THE DRAWINGS

The accompanying drawings are incorporated in and constitute part of the specification, illustrate an embodiment of the present invention and, together with the description thereof, serve to explain the principles of the present invention.

FIG. 1 is a block diagram of a control system for vehicle according to an embodiment.

FIG. 2 is another block diagram showing the control system for vehicle according to the embodiment.

FIG. 3 is another block diagram showing the control system for vehicle according to the embodiment.

FIG. 4 is a functional block diagram for achieving an example of processes carried out by the system according to the embodiment.

FIG. 5 is a flowchart showing an example of processes carried out by the system according to the embodiment.

FIG. 6 describes changes in speed in various deceleration modes in the embodiment.

### DESCRIPTION OF THE EMBODIMENTS

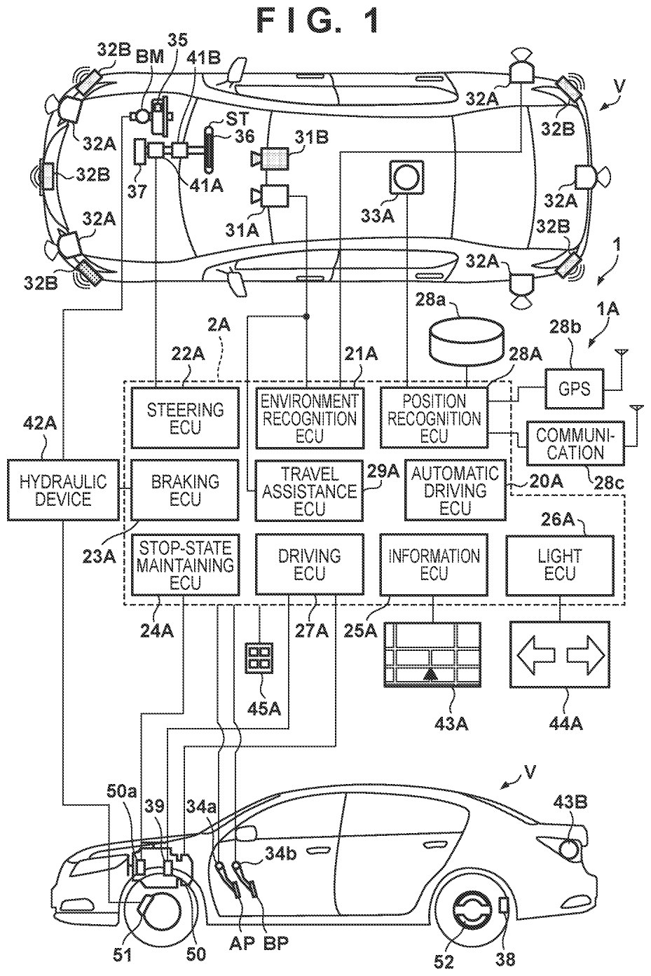

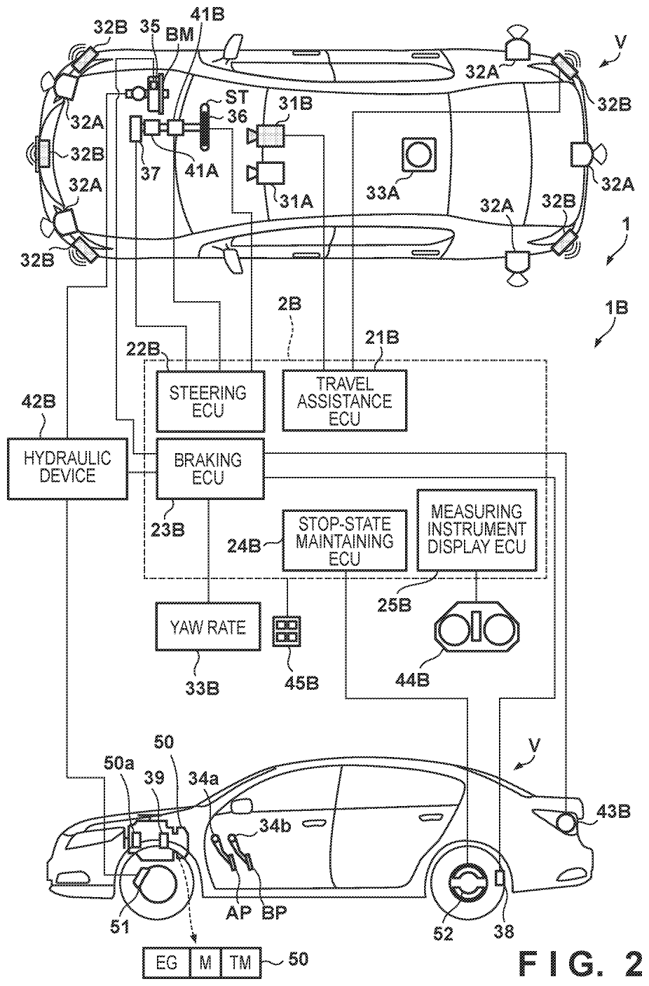

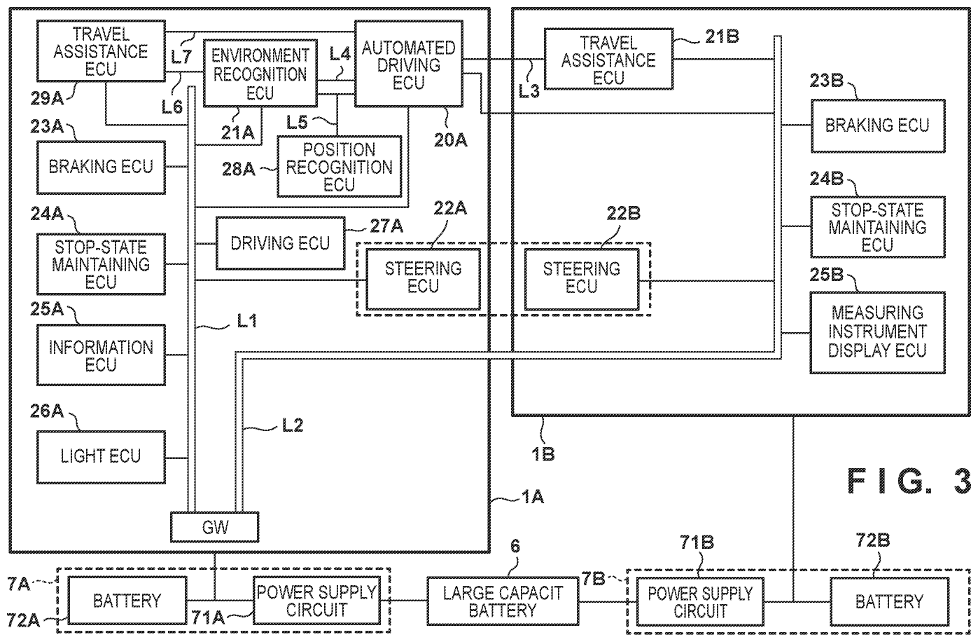

FIGS. 1 to 3 are block diagrams of a control system 1 for vehicle according to an embodiment of the present invention. The control system 1 controls a vehicle V. In FIGS. 1 and 2, the vehicle V is schematically shown in the form of a plane view and a side view. The vehicle V is a sedan-type, four-wheeled passenger car by way of example. The control system 1 includes a control apparatus 1A and a control apparatus 1B. FIG. 1 is a block diagram showing the control apparatus 1A, and FIG. 2 is a block diagram showing the control apparatus 1B. FIG. 3 primarily shows communication lines between the control apparatus 1A and the control apparatus 1B and the configuration of a power supply.

The control apparatus 1A and the control apparatus 1B are each a device that performs part of functions achieved by the vehicle V in a multiplexing or redundant manner. The reliability of the system can thus be improved. The control apparatus 1A also performs, for example, automated driving control, typical action control in the manual driving, and even travel assistance control relating, for example, to risk avoidance. The control apparatus 1B is responsible for the travel assistance control relating, for example, to risk avoidance. The travel assistance is also called driving assistance in some cases. Causing the control apparatus 1A and the control apparatus 1B to perform different types of control while causing them to perform the functions thereof in a redundant manner allows improvement in the reliability of the system with all the types of control distributed.

The vehicle V according to the present embodiment is a hybrid vehicle based on a parallel method, and FIG. 2 diagrammatically shows the configuration of a power plant 50, which outputs driving force that rotates the driving wheels of the vehicle V. The power plant 50 includes an internal combustion engine EG, a motor M, and an automatic transmission TM. The motor M can be used as a drive source that accelerates the vehicle V and can also be used as a generator, for example, at the time of deceleration (regenerative braking).

<Control Apparatus 1A>

The configuration of the control apparatus 1A will be described with reference to FIG. 1. The control apparatus 1A includes an ECU group (control unit group) 2A. The ECU group 2A includes a plurality of ECUs 20A to 29A. The ECUs each include a processor represented by a CPU, a storage device, such as a semiconductor memory, an interface with an external device, and other components. The storage device stores a program executed by the processor, data used when the processor carries out a process, and other pieces of information. The ECUs may each include a plurality of processors, storage devices, interfaces, and other components. The number of ECUs and the functions for which the ECUs are responsible can be designed as appropriate, and the ECUs can each be divided into smaller portions than in the present embodiment or can be integrated with each other. In FIGS. 1 and 3, the ECUs 20A to 29A are each labeled with the name of a representative function thereof. For example, the ECU 20A is labeled with “automated driving ECU”.

The ECU 20A performs control relating to the automated driving as control of travel of the vehicle V. In the automated driving, the ECU 20A automatically performs at least one of driving of the vehicle V (such as acceleration of vehicle V performed by power plant 50), steering, and/or braking irrespective of a driver's driving operation. In the present embodiment, the ECU 20A automatically performs the driving, steering, and braking.

The ECU 21A is an environment recognition unit that recognizes the environment in which the vehicle V travels based on the results of sensing performed by sensing units 31A and 32A, which each sense the situations around the vehicle V. The ECU 21A produces target object data, which will be described later, as surrounding environment information.

In the present embodiment, the sensing unit 31A is an imaging device (hereinafter referred to as camera 31A in some cases) that senses an object around the vehicle V via imaging operation. The camera 31A is so provided at a front portion of the roof of the vehicle V as to be capable of capturing an image of a region in front of the vehicle V. Analysis of an image captured with the camera 31A allows extraction of the contour of a target object and extraction of a divider line (such as white line) that separates lanes on a road from each other.

In the present embodiment, the sensing unit 32A is a lidar (light detection and ranging) that senses an object around the vehicle V with light (hereinafter referred to as lidar 32A in some cases), senses a target object around the vehicle V, and measures the distance to the target object. In the present embodiment, the lidar 32A is formed of five lidars, with two lidars provided at opposite corners of a front portion of the vehicle V, one lidar provided at the center of a rear portion of the vehicle V, and two lidars provided at opposite sides of the rear portion of the vehicle V. The number of lidars 32A and the arrangement thereof can be selected as appropriate.

The ECU 29A is a travel assistance unit that performs control relating to travel assistance (in other words, driving assistance) as travel control of the vehicle V based on the result of the sensing performed by the sensing unit 31A.

The ECU 22A is a steering control unit that controls a motorized power steering device 41A. The motorized power steering device 41A includes a mechanism that steers the front wheels in accordance with the driver's driving operation (steering operation) of a steering wheel ST. The motorized power steering device 41A includes a motor that assists the steering operation or produces driving force for automatically steering the front wheels, a sensor that senses the amount of rotation of the shaft of the motor, a torque sensor that senses steering torque acting on the driver, and other components.

The ECU 23A is a braking control unit that controls a hydraulic device 42A. The driver's braking operation performed on a brake pedal BP is converted by a brake master cylinder BM into liquid pressure, which is transmitted to the hydraulic device 42A. The hydraulic device 42A is an actuator capable of controlling the liquid pressure of working fluid supplied to a brake device (disc brake device, for example) 51 provided at each of the four wheels based on the liquid pressure transmitted from the brake master cylinder BM, and the ECU 23A performs control of driving an electromagnetic valve and other components provided in the hydraulic device 42A. In the present embodiment, the ECU 23A and the hydraulic device 42A form a motorized servo brake, and the ECU 23A controls, for example, distribution of the braking force produced by four brake devices 51 and the braking force produced by the regenerative braking performed by the motor M.

The ECU 24A is a stop-state maintaining control unit that controls a motorized parking lock device 50a provided in the automatic transmission TM. The motorized parking lock device 50a includes a mechanism that locks an internal mechanism of the automatic transmission TM primarily when a P range (parking range) is selected. The ECU 24A can control the locking and unlocking performed by the motorized parking lock device 50a.

The ECU 25A is an in-vehicle notification control unit that controls an information output device 43A, which notifies the driver and passengers in the vehicle of information. The information output device 43A includes, for example, a display device, such as a head-up display, and a voice output device. The information output device 43A may further include a vibrator. The ECU 25A, for example, causes the information output device 43A to output a variety of pieces of information, such as the vehicle speed and the outside temperature, and information, for example, on route guidance.

The ECU 26A is an outside notification control unit that controls an information output device 44A, which notifies persons outside the vehicle of information. In the present embodiment, the information output device 44A is a direction indicator (hazard lamp), and the ECU 26A notifies persons outside the vehicle of the travel direction of the vehicle V by causing the information output device 44A as the direction indicator to blink and allows the persons outside the vehicle to be more alert to the vehicle V by causing the information output device 44A as the hazard lamp to blink.

The ECU 27A is a driving control unit that controls the power plant 50. In the present embodiment, one ECU 27A is allocated to the power plant 50, and the ECU may instead be allocated to each of the internal combustion engine EG, the motor M, and the automatic transmission TM. The ECU 27A controls the output from the internal combustion engine EG and the motor M and switches a gear ratio to another in the automatic transmission TM in correspondence, for example, with the driver's driving operation, the vehicle speed, and other factors sensed with an operation sensing sensor 34a provided at an accelerator pedal AP and an operation sensing sensor 34b provided at the brake pedal BP. As a sensor that senses the traveling state of the vehicle V, the automatic transmission TM is provided with a rotational speed sensor 39, which senses the rotational speed of the output shaft of the automatic transmission TM. The vehicle speed of the vehicle V can be computed from the result of the sensing performed with the rotational speed sensor 39.

The ECU 28A is a position recognition unit that recognizes the current position and travel route of the vehicle V. The ECU 28A controls a gyro sensor 33A, a GPS sensor 28b, and a communication device 28c and processes information on the results of sensing or communication performed thereby. The gyro sensor 33A senses the rotational motion of the vehicle V. The result of the sensing performed by the gyro sensor 33, for example, allows determination of the travel route of the vehicle V. The GPS sensor 28b senses the current position of the vehicle V. The communication device 28c wirelessly communicates with a server that provides map information and traffic information and acquires the information. A database 28a can store high-accuracy map information, and the ECU 28A allows more accurate identification of the on-lane position of the vehicle V based, for example, on the map information.

An input device 45A is so disposed in the vehicle as to be operable by the driver and receives an instruction from the driver and an input of information therefrom.

<Control Apparatus 1B>

The configuration of the control apparatus 1B will be described with reference to FIG. 2. The control apparatus 1B includes an ECU group (control unit group) 2B. The ECU group 2B includes a plurality of ECUs 21B to 25B. The ECUs each include a processor represented by a CPU, a storage device, such as a semiconductor memory, an interface with an external device, and other components. The storage device stores a program executed by the processor, data used when the processor carries out a process, and other pieces of information. The ECUs may each include a plurality of processors, storage devices, interfaces, and other components. The number of ECUs and the functions for which the ECUs are responsible can be designed as appropriate, and the ECUs can each be divided into smaller portions than in the present embodiment or can be integrated with each other. In FIGS. 2 and 3, the ECUs 21B to 25B are each labeled with the name of a representative function thereof, as in the case of the ECU group 2A.

The ECU 21B is an environment recognition unit that recognizes the environment in which the vehicle V travels based on the results of sensing performed by sensing units 31B and 32B, which each sense the situations around the vehicle V and is also a travel assistance unit that performs control relating to travel assistance (in other words, driving assistance) as travel control of the vehicle V. The ECU 21B produces target object data, which will be described later, as surrounding environment information.

In the present embodiment, the ECU 21B is configured to have the environment recognition function and the travel assistance function, and ECUs may instead be provided on a function basis, as in the case of the ECUs 21A and 29A of the control apparatus 1A. Conversely, in the control apparatus 1A, one ECU may achieve the functions of the ECUs 21A and 29A, as in the case of the ECU 21B.

In the present embodiment, the sensing unit 31B is an imaging device (hereinafter referred to as camera 31B in some cases) that senses an object around the vehicle V via imaging operation. The camera 31B is so provided at a front portion of the roof of the vehicle V as to be capable of capturing an image of a region in front of the vehicle V. Analysis of an image captured with the camera 31B allows extraction of the contour of a target object and extraction of a divider line (such as white line) that separates lanes on a road from each other. In the present embodiment, the sensing unit 32B is a millimeter-wave radar that senses an object around the vehicle V with an electric wave (hereinafter referred to as radar 32B in some cases), senses a target object around the vehicle V, and measures the distance to the target object. In the present embodiment, the radar 32B is formed of five radars, with one radar provided at the center of a front portion of the vehicle V, two radars provided at opposite corners of the front portion of the vehicle V, and two radars provided at opposite corners of a rear portion of the vehicle V. The number of radars 32B and the arrangement thereof can be selected as appropriate.

The ECU 22B is a steering control unit that controls a motorized power steering device 41B. The motorized power steering device 41B includes a mechanism that steers the front wheels in accordance with the driver's driving operation (steering operation) of the steering wheel ST. The motorized power steering device 41B includes a motor that assists the steering operation or produces driving force for automatically steering the front wheels, a sensor that senses the amount of rotation of the shaft of the motor, a torque sensor that senses steering torque acting on the driver, and other components. A steering angle sensor 37 is electrically connected to the ECU 22B via a communication line L2, which will be described later, and the motorized power steering device 41B can be controlled based on the result of the sensing performed by the steering angle sensor 37. The ECU 22B can acquire the result of sensing performed by a sensor 36, which senses whether or not the driver is grasping the steering handle ST, and can therefore monitor the state of the driver's grasping of the steering handle ST.

The ECU 23B is a braking control unit that controls a hydraulic device 42B. The driver's braking operation performed on the brake pedal BP is converted by the brake master cylinder BM into liquid pressure, which is transmitted to the hydraulic device 42B. The hydraulic device 42B is an actuator capable of controlling the liquid pressure of the working fluid supplied to the brake device 51 provided at each of the wheels based on the liquid pressure transmitted from the brake master cylinder BM, and the ECU 23B performs control of driving an electromagnetic valve and other components provided in the hydraulic device 42B.

In the present embodiment, a wheel speed sensor 38, a yaw rate sensor 33B, a pressure sensor 35, which senses the pressure in the brake master cylinder BM, which are provided at each of the four wheels, are electrically connected to the ECU 23B and the hydraulic device 42B and achieve an ABS function, traction control, and an attitude control function of controlling the attitude of the vehicle V based on the results of the sensing performed by the sensors. For example, the ECU 23B adjusts the braking force acting on the four wheels based on the result of the sensing performed by the wheel speed sensor 38 provided at each of the wheels to suppress sliding of the wheels. The ECU 23B further adjusts the braking force acting on the wheels based on the rotary angular speed around the vertical axis of the vehicle V sensed by the yaw rate sensor 33B to suppress an abrupt change in the attitude of the vehicle V.

The ECU 23B also functions as an outside notification control unit that controls an information output device 43B, which notifies persons outside the vehicle of information. In the present embodiment, the information output device 43B is a brake lamp, and the ECU 23B can turn on the brake lamp, for example, at the time of braking. The ECU 23B therefore allows the vehicles following the vehicle V to be more alert thereto.

The ECU 24B is a stop-state maintaining control unit that controls a motorized parking brake device (drum brake, for example) 52 provided at the rear wheels. The motorized parking brake device 52 includes a mechanism that locks the rear wheels. The ECU 24B can control the locking and unlocking of the rear wheels performed by the motorized parking brake device 52.

The ECU 25B is an in-vehicle notification control unit that controls an information output device 44B, which notifies the driver and passengers in the vehicle of information. In the present embodiment, the information output device 44B includes a display device disposed at an instrument panel. The ECU 25B can output a variety of pieces of information, such as the vehicle speed and the fuel consumption, to the information output device 44B.

An input device 45B is so disposed in the vehicle as to be operable by the driver and receives an instruction from the driver and an input of information therefrom.

<Communication Lines>

An example of the communication lines, which communicably connect the ECUs to each other, in the control system 1 will be described with reference to FIG. 3. The control system 1 includes wired communication lines L1 to L7. The ECUs 20A to 27A and 29A of the control apparatus 1A are connected to the communication line L1. The ECU 28A may also be connected to the communication line L1.

The ECUs 21B to 25B of the control apparatus 1B are connected to the communication line L2. The ECU 20A of the control apparatus 1A is also connected to the communication line L2. The communication line L3 connects the ECU 20A to the ECU 21B. The communication line L4 connects the ECU 20A to the ECU 21A. The communication line L5 connects the ECUs 20A, 21A, and 28A to each other. The communication line L6 connects the ECU 29A to the ECU 21A. The communication line L7 connects the ECU 29A to the ECU 20A.

The communication lines L1 to L7 may operate in accordance with the same protocol or different protocols. In the latter case, the protocols differ from one another in accordance with the communication environment, such as the communication speed, the amount of communication, and the durability of the communication lines. For example, in terms of communication speed, the communication lines L3 and L4 may each be a communication line compliant with Ethernet (registered trademark). For example, the communication lines L1, L2, and L5 to L7 may each be a communication line compliant with CAN.

The control apparatus 1A includes a gateway GW. The gateway GW relays the communication line L1 to the communication line L2 and vice versa. Therefore, for example, the ECU 21B can output a control instruction to the ECU 27A via the communication line L2, the gateway GW, and the communication line L1.

<Power Supply>

The power supply of the control system 1 will be described with reference to FIG. 3. The control system 1 includes a large capacity battery 6, a power supply 7A, and a power supply 7B. The large capacity battery 6 is a battery for driving the motor M and is charged by the motor M.

The power supply 7A is a power supply that supplies the control apparatus 1A with electric power and includes a power supply circuit 71A and a battery 72A. The power supply circuit 71A is a circuit that supplies the control apparatus 1A with the electric power from the large capacity battery 6 and, for example, lowers the voltage output from the large capacity battery 6 (190 V, for example) to reference voltage (12 V, for example). The battery 72A is, for example, a 12-V lead battery. Providing the battery 72A allows electric power to be supplied to the control apparatus 1A even when the supply of the electric power from the large capacity battery 6 and the power supply circuit 71A is terminated or suppressed.

The power supply 7B is a power supply that supplies the control apparatus 1B with electric power and includes a power supply circuit 71B and a battery 72B. The power supply circuit 71B is similar to the power supply circuit 71A and is a circuit that supplies the control apparatus 1B with the electric power from the large capacity battery 6. The battery 72B is similar to the battery 72A and is, for example, a 12-V lead battery. Providing the battery 72B allows electric power to be supplied to the control apparatus 1B even when the supply of the electric power from the large capacity battery 6 and the power supply circuit 71B is terminated or suppressed.

<Exemplary Control>

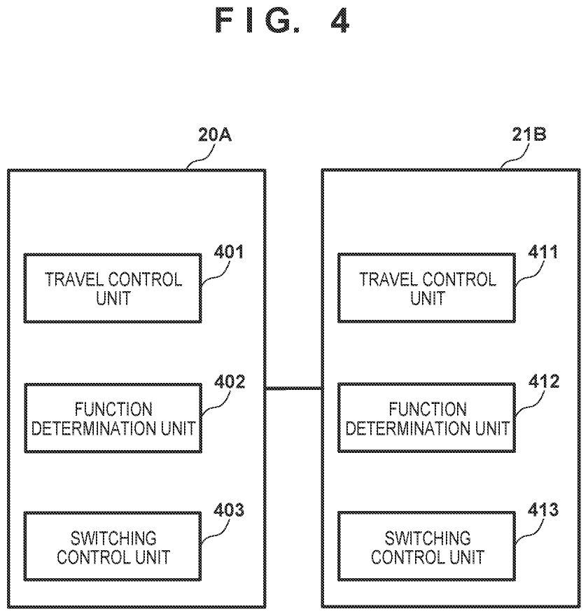

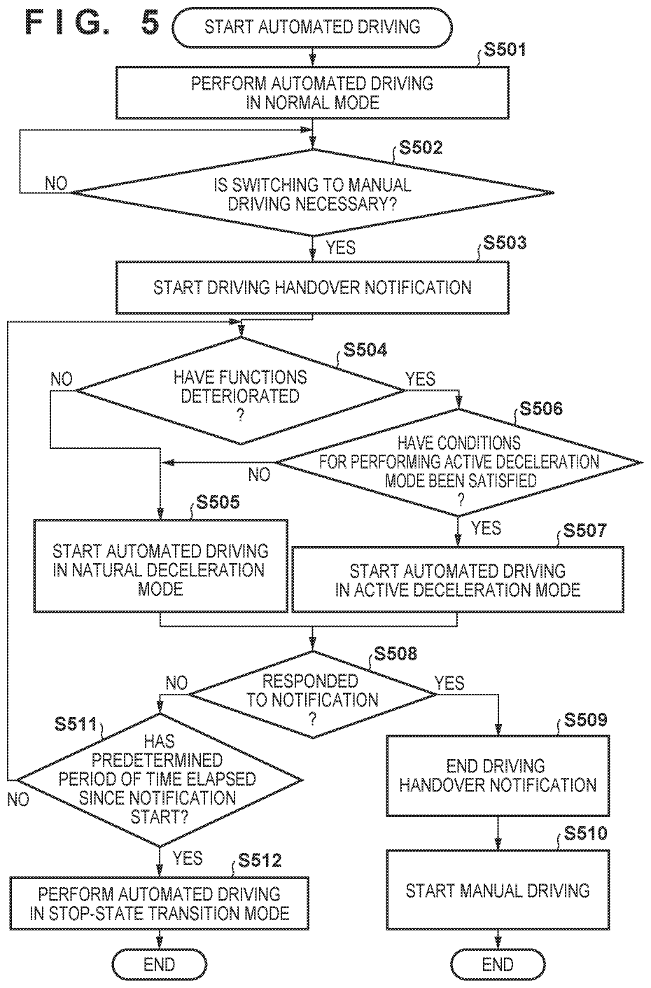

An example of the control of the control system 1 will be described with reference to FIGS. 4 and 5. FIG. 5 is a flowchart for describing the action performed after the automated driving starts. FIG. 4 describes the functions of the ECUs 20A and 21B for carrying out the flowchart shown in FIG. 5. The ECUs 20A and 21B function as a control apparatus that controls the vehicle V.

The ECU 20A includes a travel control unit 401, a function determination unit 402, and a switching control unit 403. The travel control unit 401, the function determination unit 402, and the switching control unit 403 may each be achieved by a dedicated circuit, such as an ASIC (application specific integrated circuit), or may be achieved when a general-purpose processor, such as a CPU, executes a program read into a memory. The travel control unit 401 performs the automated driving of the vehicle V. Specifically, the travel control unit 401 outputs control instructions to the ECUs 22A, 23A, and 27A to control the actuator group including a steering actuator, a braking actuator, and a driving actuator of the vehicle V in such a way that the vehicle V automatically travels irrespective of the driver's driving operation. The travel control unit 401 sets a travel route along which the vehicle V travels and refers to the result of the position recognition performed by the ECU 28A and the surrounding environment information (result of sensing of target object) to cause the vehicle V to travel along the set travel route. The function determination unit 402 determines whether the functions of the travel control unit 401 and the actuator group of the vehicle V have deteriorated. The switching control unit 403 controls the switching between the automated driving and the manual driving.

The ECU 21B includes a travel control unit 411, a function determination unit 412, and a switching control unit 413. The travel control unit 411 performs the automated driving of the vehicle V. Specifically, the travel control unit 401 is a travel assistance unit that performs control relating to travel assistance (in other words, driving assistance) as travel control of the vehicle V. The function determination unit 412 and the switching control unit 413 perform the same actions as those performed by the function determination unit 402 and the switching control unit 403.

In the example described above, the ECU 20A includes the travel control unit 401, and the ECU 21B includes the travel control unit 411. That is, the ECUs 20A and 21B form the travel control units 401 and 411. Since the function determination unit 412 and the switching control unit 413 perform the same actions as those performed by the function determination unit 402 and the switching control unit 403, one of the ECUs 20A and 21B may preferentially perform the actions. For example, when the function of the ECU 20A has not deteriorated, the function determination unit 402 and the switching control unit 403 of the ECU 20A operate, whereas the function determination unit 412 and the switching control unit 413 of the ECU 21B stop operating. When the function of the ECU 20A has deteriorated, the function determination unit 412 and the switching control unit 413 of the ECU 21B may operate and take over the processes. In place of or in addition to the ECU 21B, the ECU 29A may have the same configuration as that of the ECU 21B and perform the same action.

The action performed after the automated driving starts will subsequently be described with reference to FIG. 5. The following description will be made of the case where the ECU 20A performs the action. Instead, in cooperation with or in place of the ECU 20A, the ECU 21B may perform at least part of the action. The flowchart shown in FIG. 5 starts, for example, when the driver of the vehicle V instructs start of the automated driving.

In step S501, the ECU 20A (travel control unit 401) performs the automated driving in a normal mode. The normal mode is a mode in which the steering, driving, and braking are all performed as required to try to reach a destination.

In step S502, the ECU 20A (switching control unit 403) determines whether switching to the manual driving is necessary. In a case where the switching is necessary (“YES” in S502), the ECU 20A proceeds to the process in step S503, whereas in a case where the switching is unnecessary (“NO” in S502), the ECU 20A repeats the step S502. The ECU 20A determines that the switching to the manual driving is necessary, for example, when the function determination unit 402 determines that part of the functions of the vehicle V has deteriorated, when it is difficult to continue the automated driving due to a change in the surrounding traffic conditions, or when the vehicle V has reached a point in the vicinity of a destination set by the driver.

In step S503, the ECU 20A (switching control unit 403) starts driving handover notification. The driving handover notification is notification for requesting the driver to switch to the manual driving. The actions in subsequent steps S504 to S508, S511, and S512 are performed during the driving handover notification.

In step S504, the ECU 20A (function determination unit 402) determines whether the functions of the travel control unit and the actuator group have deteriorated. When the functions have not deteriorated (“NO” in step S504), the ECU 20A proceeds to the process in step S505, whereas when the functions have deteriorated (“YES” in step S504), the ECU 20A proceeds to the process in step S506.

In step S505, the ECU 20A (travel control unit 401) starts the automated driving in a natural deceleration mode. The natural deceleration mode is a mode in which only the steering is performed as required to wait for the driver's response to the driving handover notification. In the natural deceleration mode, no active braking is performed by the ECU 23A, but the vehicle V is decelerated by engine braking or regenerative braking. When the functions of the travel control unit or the actuator group have not deteriorated, performing no active braking allows reduction in the degree of discomfort felt by the driver in the driving handover.

In step S506, the ECU 20A (travel control unit 401) determines whether the conditions for performing an active deceleration mode have been satisfied. When the conditions have been satisfied (“YES” in step S506), the ECU 20A proceeds to the process in step S507, whereas when the conditions have not been satisfied (“NO” in step S506), the ECU 20A proceeds to the process in step S505. The conditions for performing the active deceleration mode will be described later.

In step S507, the ECU 20A (travel control unit 401) starts the automated driving in the active deceleration mode. The active deceleration mode is a mode in which the steering is performed as required to wait for the driver's response to the driving handover notification with the vehicle V decelerated by a greater degree than in the natural deceleration mode. To increase the degree of deceleration, the ECU 20A may perform braking using the braking actuator (frictional braking, for example), may use deceleration regeneration (for example, by increasing the amount of regeneration), or may use engine braking (for example, by changing a gear ratio to lower one). Further, the ECU 20A may start the deceleration at an earlier timing than in the natural deceleration mode to decelerate the vehicle V by an increased degree. In the case where the functions of the travel control unit and the actuator group have deteriorated, it is believed that handing over the driving to the driver with the vehicle V having low kinetic energy allows smooth handover to the driver. To this end, the ECU 20A starts the automated driving in the active deceleration mode to actively lower the speed of the vehicle V to lower the kinetic energy of the vehicle V.

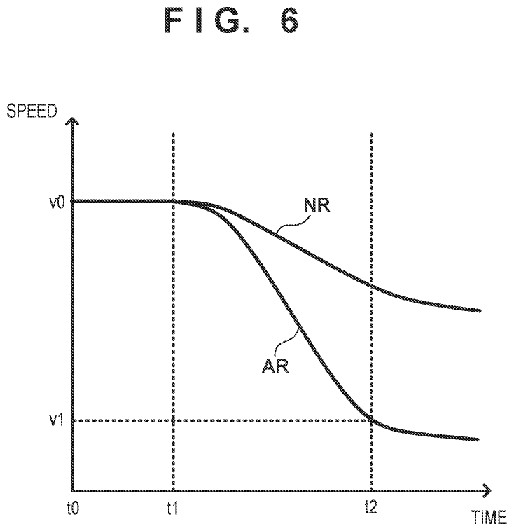

Changes in the speed in the deceleration modes will be described with reference to FIG. 6. The graph NR shows a change in the speed of the vehicle V in the natural deceleration mode, and the graph AR shows a change in the speed of the vehicle V in the active deceleration mode. It is assumed that the vehicle speed at time t0 is v0 and the vehicle V travels at a fixed speed. At time t1, the determination in step S502 is performed, and the result of the determination shows that the switching to the manual driving is necessary. The vehicle V is then decelerated in any of the deceleration modes, and the active deceleration mode allows faster deceleration than the natural deceleration mode, as shown in FIG. 6. That is, the speed at the same point of time is slower in the active deceleration mode than in the natural deceleration mode.

Even in the case where the functions of the travel control unit and the actuator group have deteriorated, it is unnecessary in some cases to actively lower the speed of the vehicle V, for example, when the vehicle V has already traveled at a sufficiently low speed. Therefore, in the present embodiment, when the conditions for performing the active deceleration mode have not been satisfied in step S506, the automated driving in the active deceleration mode does not start, but the automated driving in the natural deceleration mode starts. The conditions described above may be based, for example, on the traveling state of the vehicle V. Specifically, the active deceleration mode may be performed when the vehicle speed of the vehicle V is equal to a threshold speed (for example, legal speed limit on a road along which the vehicle V is traveling: 20 km/hour). If the vehicle speed is lowered to a value smaller than the threshold speed, the difference in speed between the vehicle V and the other vehicles increases, so that the handover is in contrast unlikely to be smoothly performed. The threshold speed can be called a deceleration end speed in the active deceleration mode. That is, in the active deceleration mode, the deceleration is actively performed until the deceleration end speed is reached, and the active deceleration mode transitions to the natural deceleration mode when the deceleration end speed is reached. For example, it is assumed in FIG. 6 that the vehicle speed in the active deceleration mode reaches a deceleration end speed v1 at time t2. In this case, the ECU 20A performs the deceleration in the natural deceleration mode after the time t2. The condition described above may be based, for example, on the situation of detection performed by an exterior sensor and the current traveling vehicle speed. Specifically, when the sensing performance of the exterior sensor lowers from 100 m to 50 m as a result of deterioration of the function of the exterior sensor, the active deceleration mode may be performed when the vehicle speed is higher than or equal to the speed that does not allows the vehicle V to avoid an unexpected event that occurs at a point in front of the vehicle V by 50 m.

In step S508, the ECU 20A (switching control unit 403) determines whether the driver has responded to the driving handover notification. When the driver has responded (“YES” in step S508), the ECU 20A proceeds to the process in step S509, whereas when the driver has not responded (“NO” in step S508), the ECU 20A proceeds to the process in step S511. The driver can show the drier's intention of transition to the manual driving, for example, via the input device 45A. The driver may instead show the drier's intention of agreement based on the result of detection of the driver's steering detected by a steering torque sensor.

In step S509, the ECU 20A (switching control unit 403) terminates the driving handover notification. In step S510, the ECU 20A (travel control unit 401) terminates the automated driving in the natural deceleration mode or the active deceleration mode being performed and starts the manual driving. In the manual driving, the ECUs of the control apparatuses 1A and 1B each control the traveling of the vehicle V in accordance with the driver's driving operation. Since the performance of the ECU 20A is likely to have, for example, deteriorated, the ECU 29A may cause the information output device 43A to output a message that prompts the driver to take the vehicle V to a repair shop.

In step S511, the ECU 20A (switching control unit 403) determines whether a predetermined period (period according to automated driving level of vehicle V, for example, 4 seconds or 15 seconds) has elapsed since the start of the driving handover notification. When the predetermined period has elapsed (“YES” in S511), the ECU 20A proceeds to the process in step S512, whereas when the predetermined period has not elapsed (“NO” in S511), the ECU 20A returns to the process in step S504 and repeats the processes in step S504 and the following steps.

In step S512, the ECU 20A (travel control unit 401) terminates the automated driving in the natural deceleration mode or the active deceleration mode being performed and performs the automated driving in a stop-state transition mode. The stop-state transition mode is a mode that causes the vehicle V to be stopped in a safe position or the vehicle speed to be decelerated to a speed slower than the deceleration end speed in the active deceleration mode. Specifically, the ECU 20A searches for a position where the vehicle V can be stopped while actively decelerating the vehicle V to a speed slower than the deceleration end speed in the active deceleration mode. When a stoppable position has been successfully found, the ECU 20A stops the vehicle V at the position, whereas when no stoppable position has been successfully found, the ECU 20A searches for a stoppable position while causing the vehicle V to travel at a very slow speed (creep speed, for example). The ECU 20A then determines whether the vehicle V has stopped based on the result of the sensing performed by the rotational speed sensor 39. When the ECU 20A determines that the vehicle V has stopped, the ECU 20A instructs the ECU 24A to activate the motorized parking lock device 50a to maintain the state of the stopped vehicle V. When the automated driving is performed in the stop-state transition mode, the hazard lamp or any other display device may be used to notify other vehicles around the vehicle V that the vehicle V is transitioning to a stop state, or the communication device may be used to notify other vehicles and other terminal devices of the same.

In step S504, the ECU 20A (function determination unit 402) may determine that the functions of the travel control unit and the actuator group have deteriorated when at least a function of any of the ECU 20A, the ECU 21B, the braking actuator (hydraulic devices 42A, 42B, for example), the steering actuator (motorized power steering devices 41A, 41B, for example), and/or the power supplies 7A and 7B has deteriorated, whereas the ECU 20A (function determination unit 402) may determine that the function of the travel control unit or the actuator group has not deteriorated when the function of another mechanism has deteriorated. As described above, the automated driving in the active deceleration mode starts only when the function of a mechanism that greatly affects the traveling, so that unnecessary deceleration is not performed.

Specific scenarios of the action described above will be described below. In a first scenario, when the functions of the travel control unit and the actuator group have deteriorated, the driving handover notification starts. When the driving handover notification starts, the ECU 20A starts the automated driving in the active deceleration mode. When the speed of the vehicle V sufficiently lowers during the automated driving in the active deceleration mode, so that the conditions for performing the active deceleration mode are not satisfied, the ECU 20A causes the automated driving in the active deceleration mode to transition to the automated driving in the natural deceleration mode. Thereafter, when the driver responds to the driving handover notification, the ECU 20A terminates the driving handover notification and starts the manual driving.

In a second scenario, although the function of the travel control unit or the actuator group has not deteriorated, the driving handover notification starts in accordance with a change in the surrounding traffic conditions. When the driving handover notification starts, the ECU 20A starts the automated driving in the natural deceleration mode. It is assumed that during the automated driving in the natural deceleration mode, the functions of the travel control unit and the actuator group have deteriorated, so that the conditions for performing the active deceleration mode are satisfied. In this case, the ECU 20A causes the automated driving in the natural deceleration mode to transition to the automated driving in the active deceleration mode. The ECU 20A then causes the automated driving in the active deceleration mode to transition to the automated driving in the stop-state transition mode when the predetermined period has elapsed since the start of the driving handover notification.

The above embodiment has been described with reference to the case where the driving, braking, and steering are all automated as the automated driving control performed by the ECU 20A in the automated driving mode. The automated driving control may instead control at least one of the driving, braking, and/or steering irrespective of the driver's driving operation. It can be said that the control irrespective of the driver's driving operation include a situation in which the control is performed even when no driver's input is made to an operation component represented by the steering handle and the pedals, or that the driver's intention of driving the vehicle is not essential to the control. Therefore, the driver may be responsible for monitoring the surroundings, and the automated driving control may control at least one of the driving, braking, and/or steering of the vehicle V in accordance with the information on the environment around the vehicle V; the driver may be responsible for monitoring the surroundings, and the automated driving control may control the steering and at least one of the driving and/or braking of the vehicle V in accordance with the information on the environment around the vehicle V; or the driver is not responsible for monitoring the surroundings, and the automated driving control may control all the driving, braking, and steering of the vehicle V in accordance with the information on the environment around the vehicle V. Further, the automated driving control may be capable of transition to any of the control stages described above. Moreover, a sensor that senses information on the state of the driver (biological information, such as heart beat, or information on the state of driver's facial expression or driver's pupil) may be provided, and the automated driving control may be performed and suppressed in accordance with the result of the sensing performed by the sensor.

On the other hand, the driving assistance control (or traveling assistance control) performed by the ECUs 29A and 21B may control at least one of the driving, braking, and/or steering during the driver's driving operation. It can be said that during the driver's driving operation is a case where there is the driver's input made to an operation component or a case where the driver's contact with an operation component can be detected and the driver's intention of driving the vehicle is read. The driving assistance control can include both driving assistance control performed by the driver's selecting of activation thereof, for example, via switch operation and driving assistance control performed without the driver's selecting of the activation thereof. Examples of the former case in which the driver selects the activation of the driving assistance control may include preceding car tracking control and lane maintaining control. These types of control can also be defined as part of the automated driving control. Examples of the latter case in which the driving assistance control is performed without the driver's selecting of the activation thereof may include collision suppression braking control, lane deviation suppression control, and erroneous travel start suppression control.

### Summary of Embodiment

### [Configuration 1]

A control apparatus (20A, 21B) of a vehicle (V) including a travel control unit (401, 411) that performs automated driving and an actuator group controlled by the travel control unit, the control apparatus comprising:

a function determination unit (402, 412) that determines whether functions of the travel control unit and the actuator group have deteriorated; and

a switching control unit (403, 413) that controls switching between the automated driving and manual driving, wherein

when it is determined that the automated driving needs to be switched to the manual driving, the switching control unit issues driving handover notification for requesting a driver to switch to the manual driving,

during the driving handover notification, the travel control unit performs
the automated driving in a first mode when the functions of the travel control unit and the actuator group have not deteriorated, and
the automated driving in a second mode when the functions of the travel control unit and the actuator group have deteriorated, and

wherein a degree of deceleration in the automated driving in the second mode is greater than a degree of deceleration in the automated driving in the first mode.

According to the configuration described above, when the functions of the travel control unit and the actuator group have deteriorated, the automated driving in a mode in which the degree of deceleration is large is performed, so that the speed at each point of time during the driving handover notification decreases, whereby the handover at the time of switching from the automated driving to the manual driving is smoothly performed.

### [Configuration 2]

The control apparatus described in the configuration 1, wherein after a predetermined period elapses since start of the driving handover notification, the travel control unit terminates the automated driving being performed in the first or second mode and starts the automated driving in a third mode, and

in the automated driving in the third mode, the travel control unit stops the vehicle or decelerates the vehicle to a speed slower than a deceleration end speed in the second mode.

According to the configuration described above, in the automated driving in a mode in which the vehicle is stopped, the automated driving in the other modes has ended, whereby control interference can be avoided.

### [Configuration 3]

The control apparatus described in the configuration 1 or 2, wherein during the automated driving in the second mode, the travel control unit causes the automated driving in the second mode to transition to the automated driving in the first mode based on a driving state of the vehicle.

According to the configuration described above, the handover can be performed more safely by lowering the degree of the deceleration when the speed is sufficiently low.

### [Configuration 4]

The control apparatus described in any one of the configurations 1 to 3, wherein when the driver responds to the driving handover notification, the travel control unit terminates the automated driving being performed in the first or second mode and starts the manual driving.

According to the configuration described above, since the manual driving starts after the handover, driving according to the driver's intention is achieved, whereby the driver can control the vehicle in an improved manner.

### [Configuration 5]

The control apparatus described in any one of the configurations 1 to 4, wherein during the automated driving in the second mode, the travel control unit causes the automated driving in the second mode to transition to the automated driving in the first mode based on a situation detected by an exterior sensor (31A, 31B, 32A, 32B) and a current vehicle driving speed.

According to the configuration described above, minimum forcible deceleration based on the detection result and the current vehicle driving speed allows reduction in discomfort felt by the driver.

### [Configuration 6]

The control apparatus described in any one of the configurations 1 to 5, wherein

the actuator group includes a braking actuator (42A, 42B) and a steering actuator (41A, 41B),

the vehicle includes
a first ECU (20A) and a second ECU (21B) that form the travel control unit, and
a power supply (7A, 7B) that supplies the first ECU, the second ECU, the braking actuator, and the steering actuator with electric power, and

when at least a function of any of the first ECU, the second ECU, the braking actuator, the steering actuator, and/or the power supply has deteriorated, the function determination unit determines that the travel control unit and the actuator group do not operate normally.

According to the configuration described above, in which the forcible deceleration is performed only when the function of an important part deteriorates, unnecessary deceleration can be avoided.

### [Configuration 7]

A vehicle (V) comprising:

the control apparatus (20A, 21B) described in any one of the configurations 1 to 6;

a travel control unit (401, 411) that performs automated driving; and

an actuator group controlled by the travel control unit.

According to the configuration described above, a vehicle including the control apparatus described above is provided.

### [Configuration 8]

A method for controlling a vehicle (V) including a travel control unit (401, 411) that performs automated driving and an actuator group controlled by the travel control unit, the method comprising:

determining whether functions of the travel control unit and the actuator group have deteriorated;

controlling switching between the automated driving and manual driving;

issuing driving handover notification for requesting a driver to switch to the manual driving when it is determined that the automated driving needs to be switched to the manual driving;

during the driving handover notification,
performing the automated driving in a first mode when the functions of the travel control unit and the actuator group have not deteriorated; and
performing the automated driving in a second mode when the functions of the travel control unit and the actuator group have deteriorated,

wherein a degree of deceleration in the automated driving in the second mode is greater than a degree of deceleration in the automated driving in the first mode.

According to the configuration described above, when the functions of the travel control unit and the actuator group have deteriorated, the automated driving in a mode in which the degree of deceleration is large is performed, whereby the handover at the time of switching from the automated driving to the manual driving is smoothly performed.

The present invention is not limited to the above embodiment and various changes and modifications can be made within the spirit and scope of the present invention. Therefore, to apprise the public of the scope of the present invention, the following claims are made.

What is claimed is:

1. A control apparatus of a vehicle including a travel control unit that performs automated driving and an actuator group controlled by the travel control unit, the control apparatus comprising:
a function determination unit that determines whether functions of the travel control unit and the actuator group have deteriorated; and
a switching control unit that controls switching between the automated driving and manual driving, wherein
when it is determined that the automated driving needs to be switched to the manual driving, the switching control unit issues driving handover notification for requesting a driver to switch to the manual driving,
during the driving handover notification, the travel control unit performs
the automated driving in a first mode when the functions of the travel control unit and the actuator group have not deteriorated, and
the automated driving in a second mode when the functions of the travel control unit and the actuator group have deteriorated, and
wherein a degree of deceleration in the automated driving in the second mode is greater than a degree of deceleration in the automated driving in the first mode.

2. The control apparatus according to claim 1, wherein after a predetermined period elapses since start of the driving handover notification, the travel control unit terminates the automated driving being performed in the first or second mode and starts the automated driving in a third mode, and
in the automated driving in the third mode, the travel control unit stops the vehicle or decelerates the vehicle to a speed slower than a deceleration end speed in the second mode.

3. The control apparatus according to claim 1, wherein during the automated driving in the second mode, the travel control unit causes the automated driving in the second mode to transition to the automated driving in the first mode based on a driving state of the vehicle.

4. The control apparatus according to claim 1, wherein when the driver responds to the driving handover notification, the travel control unit terminates the automated driving being performed in the first or second mode and starts the manual driving.

5. The control apparatus according to claim 1, wherein during the automated driving in the second mode, the travel control unit causes the automated driving in the second mode to transition to the automated driving in the first mode based on a situation detected by an exterior sensor and a current vehicle driving speed.

6. The control apparatus according to claim 1, wherein
the actuator group includes a braking actuator and a steering actuator,
the vehicle includes
a first ECU and a second ECU that form the travel control unit, and
a power supply that supplies the first ECU, the second ECU, the braking actuator, and the steering actuator with electric power, and
when at least a function of any of the first ECU, the second ECU, the braking actuator, the steering actuator, and/or the power supply has deteriorated, the function determination unit determines that the travel control unit and the actuator group do not operate normally.

7. A vehicle comprising:
the control apparatus according to claim 1;
a travel control unit that performs automated driving; and
an actuator group controlled by the travel control unit.

8. A method for controlling a vehicle including a travel control unit that performs automated driving and an actuator group controlled by the travel control unit, the method comprising:
determining whether functions of the travel control unit and the actuator group have deteriorated;
controlling switching between the automated driving and manual driving;
issuing driving handover notification for requesting a driver to switch to the manual driving when it is determined that the automated driving needs to be switched to the manual driving;
during the driving handover notification,
performing the automated driving in a first mode when the functions of the travel control unit and the actuator group have not deteriorated; and
performing the automated driving in a second mode when the functions of the travel control unit and the actuator group have deteriorated,
wherein a degree of deceleration in the automated driving in the second mode is greater than a degree of deceleration in the automated driving in the first mode.
